(19) United States
(12) Patent Application Publication
(10) Pub. No.: US 2015/0023729 A1
(43) Pub. Date: Jan. 22, 2015

(54) OFFICE FURNITURE SYSTEM

(71) Applicant: Kimball International, Inc., Jasper, IN (US)

(72) Inventors: Jay M. Henriott, Jasper, IN (US); Keith E. Metcalf, Jasper, IN (US); Samial K. Johnson, Jasper, IN (US)

(21) Appl. No.: 14/510,355

(22) Filed: Oct. 9, 2014

Related U.S. Application Data
(63) Continuation of application No. 13/799,646, filed on Mar. 13, 2013.

(51) Int. Cl. F16B 12/40; A47B 13/02

(52) U.S. Cl. CPC F16B 12/40; A47B 13/02; A47B 2230/00; A47B 2230/07; A47B 2220/00
USPC 403/376

(57) ABSTRACT

An office furniture system for use in an open plan office environment, the furniture system configured as a “hybrid” system including features of both traditional partition systems and contemporary desking or benching systems. In one configuration, one or more work surfaces each include an electronic services bracket mounted beneath the rear edge(s) thereof, and access covers for providing selective access to electronic service modules mounted to the bracket and disposed within a raceway space beneath the rear edges of the work surfaces. The work surfaces may be associated with a partition system or, alternatively, may be associated with a desking arrangement. In another configuration, at least one electronic services module is mounted beneath a horizontal frame member of a partition, and work surface mounting brackets are used to mount one or more work surfaces on one or both sides of the partition. The work surfaces may include access covers to provide selective access to access spaces adjacent the electronic services modules.

### BACKGROUND

1. Field of the Disclosure.

The present disclosure relates to office furniture and, in particular, relates to an office furniture system for use in an open plan office environment.

2. Description of the Related Art.

Many known office furniture systems are based on traditional partition systems, which include full height panels for use in subdividing an open floor plan office space into substantially private individual spaces such as cubicles, offices, meeting rooms, and reception areas, for example.

Recently, many office furniture systems have been designed in accordance with more spatially open aesthetics, and are based on desking or benching systems and modular tables, for example, to promote increased interaction and collaboration between office workers.

What is needed in many office environments is a type of “hybrid” office furniture system which combines beneficial features of both traditional partition systems and current desking or benching systems. For example, such a “hybrid” system may afford workers some measure of privacy, such as in traditional partition systems, yet promote easy reconfiguration in open office floor plans as well as promote increased interaction among workers, such as in current desking and benching systems.

### SUMMARY

The present disclosure provides an office furniture system for use in an open plan office environment, the furniture system configured as a “hybrid” system including features of both traditional partition systems and contemporary desking or benching systems. In one configuration, one or more work surfaces each include an electronic services bracket mounted beneath the rear edge(s) thereof, and access covers for providing selective access to electronic service modules mounted to the bracket and disposed within a raceway space beneath the rear edges of the work surfaces. The work surfaces may be associated with a partition system or, alternatively, may be associated with a desking arrangement. In another configuration, at least one electronic services module is mounted beneath a horizontal frame member of a partition panel, and work surface mounting brackets are used to mount one or more work surfaces on one or both sides of the partition panel. The work surfaces may include access covers to provide selective access to access spaces adjacent the electronic services modules.

In one form thereof, the present disclosure provides an office furniture system, including a first horizontally disposed work surface having an upper face, a lower face, and a rear edge; a raceway space defined horizontally proximate the rear edge of the first work surface; a vertically oriented office furniture component disposed above the raceway space; an electronic services bracket mounted to the lower face of the first work surface, the bracket extending beneath the raceway space; and at least one electronic services module mounted to the bracket and disposed within the raceway space, the electronic services bracket accessible from the upper face of the first work surface.

In another form thereof, the present disclosure provides an office furniture system, including a partition defining first and second opposite vertical side faces and including a pair of vertical frame members supporting the partition from a floor, and at least one horizontal frame member connected to and extending between the vertical frame members, the horizontal frame member spaced upwardly from the floor; at least one electronic services module mounted beneath the horizontal frame member; a work surface support bracket secured to the horizontal frame member and extending outwardly of at least a first of the vertical side faces of the partition; a first horizontally-disposed work surface having an upper face, a lower face, and a rear edge, the first work surface secured to the work surface support bracket with the rear edge of the second work surface horizontally spaced from the first vertical side face of the partition to define a first access space; and a first access cover pivotably connected to the second work surface, the first access cover pivotable between a first open position in which the first access cover does not obstruct the first access space and the at least one electronic services module is accessible from the upper face of the first work surface, and a first closed position in which the first access cover at least partially obstructs the first access space and the at least one electronic services module is substantially inaccessible from the upper face of the first work surface.

In a further form thereof, the present invention provides an office furniture system, including a framework including a plurality of vertical frame members and a plurality of horizontal frame members, the framework defining opposite vertical side faces and the vertical and horizontal frame members further defining a framework interior; a first one of the vertical frame members including opposite front and rear faces respectively facing the vertical side faces of the framework; and a pair of opposite interior faces respectively extending between the front and rear faces, the interior faces each facing toward the framework interior; at least one of the horizontal frame members comprising a pair of end sections disposed in respective overlapping relationship with the front and rear faces of the vertical frame member; a first fastener extending through the end sections of the first horizontal frame member and the front and rear faces of the vertical frame member to rigidly connect the first horizontal frame member and the vertical frame member; and a second fastener spaced from the first fastener and extending through the first horizontal frame member, the second fastener abutting one of the interior faces of the vertical frame member.

### BRIEF DESCRIPTION OF THE DRAWINGS

The above-mentioned and other features of the disclosure, and the manner of attaining them, will become more apparent and will be better understood by reference to the following description of embodiments of the disclosure taken in conjunction with the accompanying drawings, wherein:

FIG. 1 is a perspective view of an exemplary office furniture system for an open plan office environment in accordance with the present disclosure;

FIG. 2 is a perspective view of a portion of a framework for the office furniture system of FIG. 1;

FIG. 3 is a perspective view of a horizontal frame member;

FIG. 4 is a perspective, partially exploded view showing a connection between a horizontal frame member and a vertical frame member at the end of a run of framework;

FIG. 5 is a perspective, partially exploded view showing a connection between a pair of horizontal frame members to a shared vertical frame member at an intermediate position with a run of framework;

FIG. 6 is a sectional view taken along lines 6-6 of FIG. 2;

FIG. 7a is a perspective view of a partition including back-to-back work surfaces or, alternatively, including a single work surface on one side of the partition;

FIG. 7b is a sectional view taken along line 7b-7b of FIG. 7a;

FIG. 7c is a sectional view taken along line 7c-7c of FIG. 7a;

FIG. 7d is a sectional view taken along line 7d-7d of FIG. 7a;

FIG. 8 is a perspective view showing a starter bracket secured to a storage component, to which a pair of horizontal frame members may be attached to begin a run of framework;

FIG. 9 is a perspective view showing a starter bracket secured to a monolithic panel, to which a pair of horizontal frame members may be attached to begin a run of framework;

FIG. 10 is a perspective view of the framework of a “T-connection” at intersecting runs of panel framework;

FIG. 11 is a perspective, partially sectioned view showing a benching assembly having an undersurface electrical assembly;

FIG. 12a is a perspective view of the benching assembly of FIG. 11;

FIG. 12b is a sectional view taken along lines 12b-12b of FIG. 12a;

FIG. 13a is a perspective view of a hinge assembly;

FIG. 13b is a perspective view of the underside of a work surface having a pivoting access cover, including the hinge assembly of FIG. 13a;

FIG. 14a is a perspective view of a corner work surface unit, including a pair of pivoting access covers, with one of the access covers shown in a partially opened position;

FIG. 14b is a perspective view of the underside of the corner work surface unit of FIG. 14a;

FIG. 15a is a perspective view of a partition including a floating electronic services structure mounted to a pair of back-to-back work surfaces beneath a partition;

FIG. 15b is a fragmentary perspective view of a power pole used in the partition of FIG. 15a;

FIG. 16 is a perspective view of a partition including a work surface support bracket mounted to the underside of the partition and supporting a pair of back-to-back work surfaces including access covers;

FIG. 17 is a perspective view of a desking arrangement showing a pair of leg assemblies;

FIG. 18a is a lower perspective view of portion of a partition framework including an overhead cabinet;

FIG. 18b is a fragmentary view of a portion of FIG. 18a; and

FIG. 19 is a perspective view of a portion of a partition framework including a tile assembly.

Corresponding reference characters indicate corresponding parts throughout the several views. The exemplifications set out herein illustrate embodiments of the disclosure and such exemplifications are not to be construed as limiting the scope of the invention in any manner.

### DETAILED DESCRIPTION

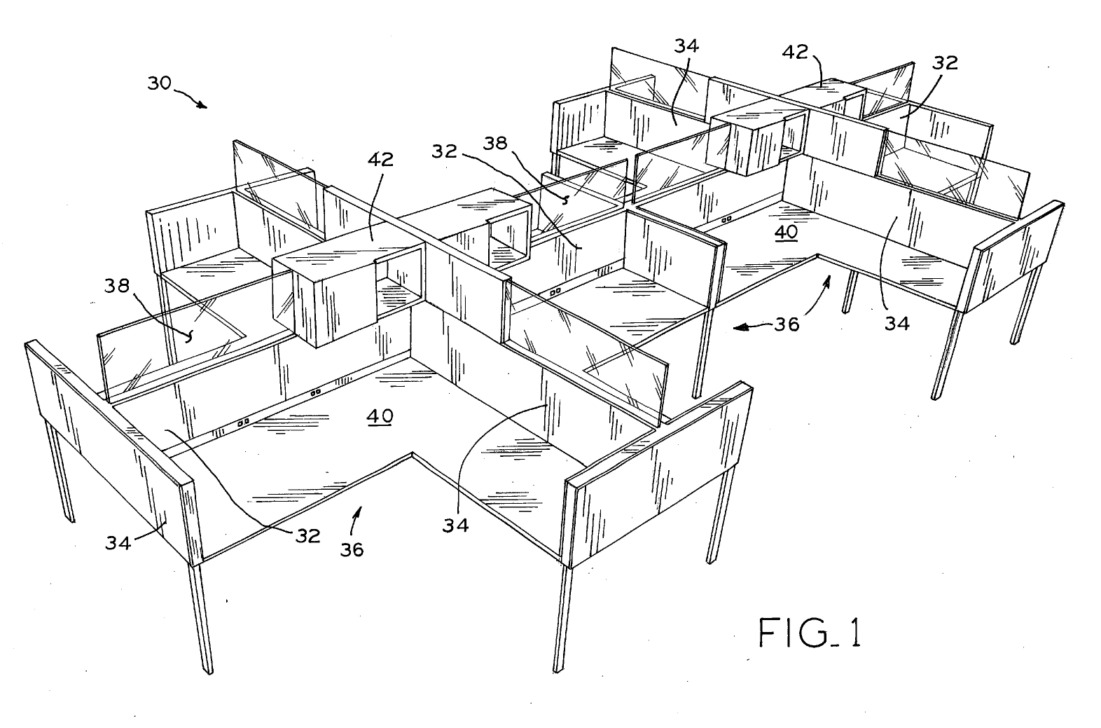

Referring now to FIG. 1, an office furniture system 30 in accordance with the present invention is shown, which is configured in an open office plan environment and generally includes a central primary partition 32, sometimes referred to as a spine partition, which carries most or all of the electrical and/or data services for the system 30. A plurality of secondary partitions 34 are connected to, and extend from, the primary partition 32 to selectively define individual office spaces 36, for example. Finally, a number of different types of accessory components, such as screens 38, work surfaces 40, and storage cabinets 42 may be attached to the primary and/or secondary partitions 32 and 34. Further features of the system 30 will be described in detail below.

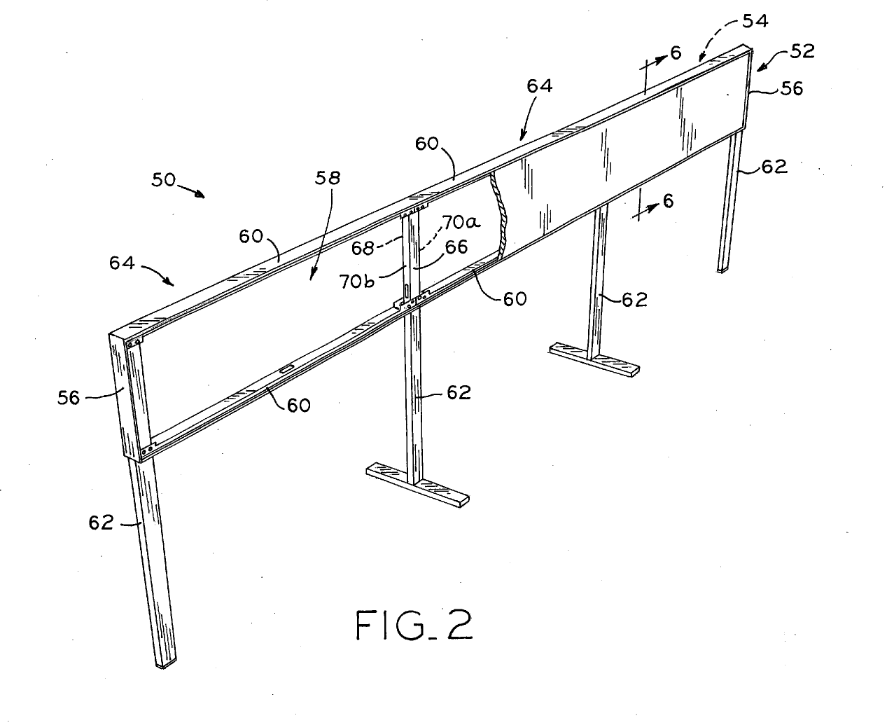

Referring to FIG. 2, a run of framework 50 of a partition is shown, with the framework 50 and partition generally including opposite front and rear vertical side faces 52 and 54 and opposite end edges 56. A partition or framework interior 58 is defined between horizontal and vertical frame members 60 and 62. Framework 50 generally includes a plurality of vertical frame members 62 and a plurality of horizontal frame members 60 which together define a plurality of framework sections 64 serially arranged along the longitudinal extent of framework 50. The framework 50 may be considered a “progressive” framework, in that adjacent neighboring pairs of framework sections 64 share common vertical frame members 62 between sections 64. In this respect, framework 50 differs from that of known partition systems which include individual rectangular frame sections each including a pair of vertical frame members and a pair of upper and lower horizontal frame members, with adjacent framework sections connected by attaching adjacent vertical frame members to one another along their vertical edges.

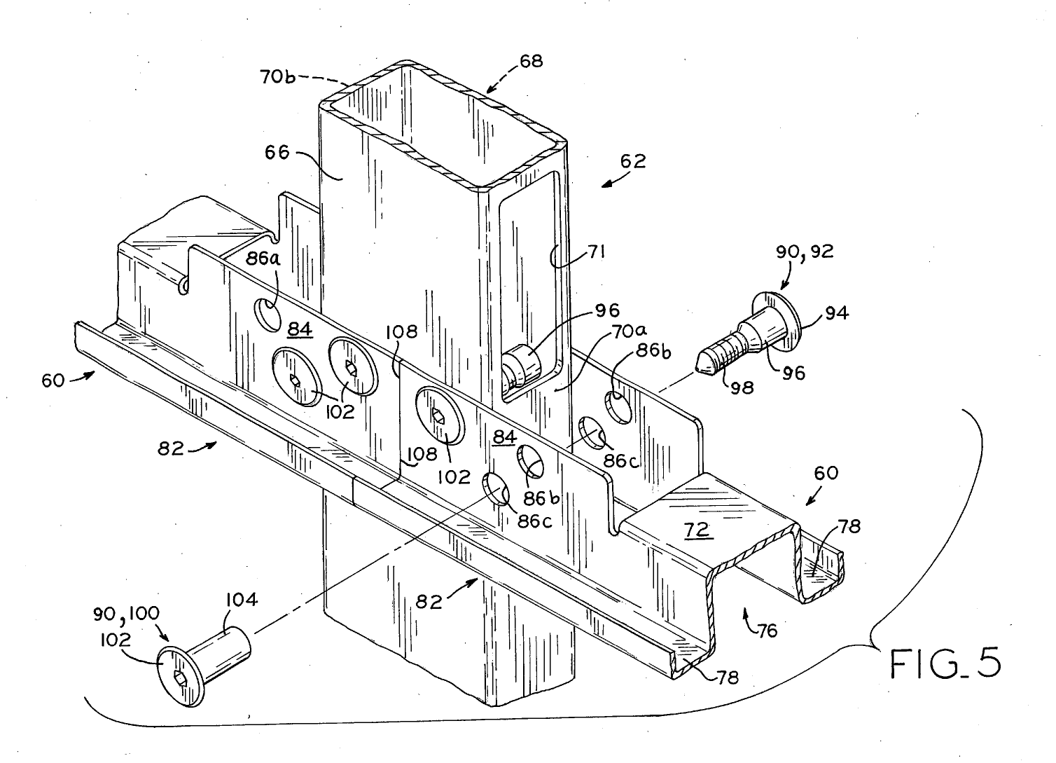

Vertical frame members 62 may be height adjustable for coarse adjustment relative to a floor surface by via telescoping feet, for example, and/or may be height adjustable for fine adjustment relative to a floor surface via threaded leveling glides, for example. Vertical frame members 62 additionally include, with further reference to FIGS. 4 and 5, opposite front and rear faces 66 and 68 respectively facing the front and rear vertical side faces 52 and 54 of the framework 50 (FIG. 2). Vertical frame members 62 also include a pair of opposite interior faces 70a and 70b respectively extending between the front and rear faces 66 and 68, with interior faces 70a and 70b each facing toward (and in some instances, defining a boundary of) interior 58 of the framework 50 (FIG. 2). Further, interior faces 70a and 70b may additionally include ports 71 therein for passage of electrical and/or data wires and cabling, for example.

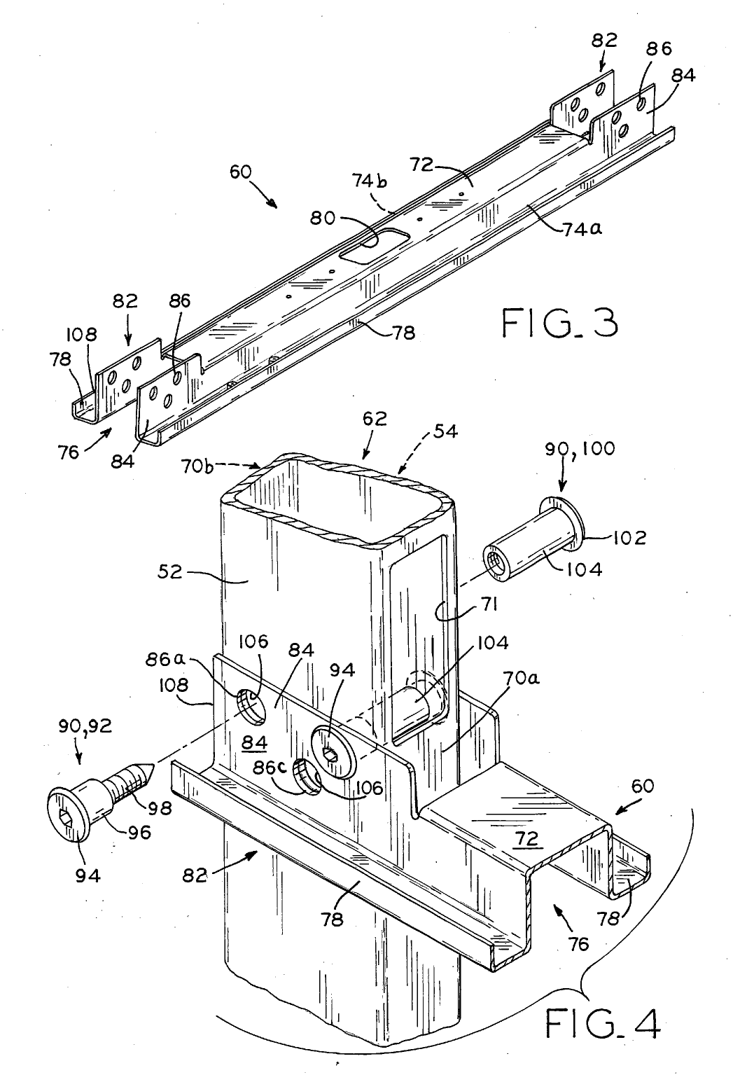

Referring to FIG. 3, a horizontal frame member 60 is shown which, in one embodiment, may be made of a single piece of rectangular metal, such as steel, which may be cut and roll- or bent-formed into the shape shown in FIG. 3 and further described below. Each horizontal frame member 60 includes a generally horizontal top flange 72 and a pair of vertical side flanges 74 defining lower channel 76. Tile support flanges 78 extend laterally outwardly from each of side flanges 74, and include horizontal and vertical components, with the horizontal components including apertures for mounting work surface brackets thereto, as described below. Top flange 72 may include one or more ports 80 for passage of wiring and/or cabling, for example, as well a number of apertures for securing brackets (not shown) for mounting electrical harness assemblies and/or other electrical components within the interior 58 of framework 50. Horizontal frame member 60 further includes opposite end sections 82 each including a pair of vertical plates 84 having a plurality of apertures 86 therein and including, with reference to FIGS. 4 and 5, horizontally-aligned first and second apertures 86a and 86b (that is, apertures 86a and 86b are have the same elevation) and a third aperture 86c in between and vertically offset from first and second apertures 86a and 86b.

Referring back to FIG. 2, the same horizontal frame members of FIG. 3 are used for both the upper and lower horizontal frame members in the framework 50, with the upper and lower horizontal frame members 60 disposed in 180° rotationally opposite positions with respect to one another about their longitudinal axes. In the illustrated arrangement, channels 76 each open outwardly (i.e., upwardly for the top frame member 60 and downwardly for the bottom frame member 60), while the channels formed by tile support flanges open inwardly (i.e., downwardly for the top frame member 60 and upwardly for the bottom frame member 60). Horizontal frame members 60 are connected to vertical frame members 62 as described below with reference to FIGS. 4 and 5.

Referring first to FIG. 4, a joint connection between a lower horizontal frame member 60 and a vertical frame member 62 at the end of a run of framework 50 is shown, it being understood that the corresponding joint connection between an upper horizontal frame member 60 and the same vertical frame member 62 is directly analogous. Fasteners 90 used to secure horizontal frame member 60 to vertical frame member 62 each include two components, namely, a first component 92 having a circular head 94 with a tool fitting (shown in FIG. 4), a cylindrical shaft portion 96, and an externally threaded end 98, and a second component 100 having a circular head 102 with a tool fitting (shown in FIG. 5) and a cylindrical shaft portion 104 which is internally threaded. The shaft portions 96 and 104 of the fasteners 90 are sized to fit closely within apertures 86a, 86b, and 86c of vertical plates 84 of horizontal frame members 60 as well as within apertures 106 in front and rear faces 52 and 54 of vertical frame member 62. In this manner, when the fasteners 90 are inserted through respective sets of aligned apertures of horizontal frame member 60 and vertical frame member 62 are positively located with respect to one another. Also, upon threading of externally threaded end 98 of first component 92 within internally threaded shaft portion 104 of second component 100, the circular heads 94, 102 of the components 92 and 100 are drawn tightly against vertical plates 84 of end sections 82 of horizontal frame member 60 to in turn draw vertical plates 84 into tight abutting engagement against the opposite front and rear faces 66 and 68 of vertical frame member 62, respectively. With two such fasteners used for each connection as shown in FIG. 4, a rigid connection is established between horizontal frame member 60 and vertical frame member 62.

Referring to FIG. 5, a joint connection is shown between a pair of horizontally aligned horizontal frame members 60 and a shared vertical frame member 62 between a pair of frame sections 64 of the partition system framework 50. The end edges 108 of horizontal frame members 60 are disposed in direct abutment with one another, and a pair of fasteners 90 are respectively used with the endmost apertures 86a of end plates 84 of end sections 82 of horizontal frame members 60 to secure same to vertical frame member 62 as described above with reference to FIG. 4. Additionally, the intermediate, vertically offset apertures 86c of end plates 84 of horizontal frame members 60 receive second sets of fasteners 90, whose shaft portions 96 and 104 each directly contact and abut the interior side faces 70a and 70b, respectively on the opposite sides of the vertical frame member 62. The use of a first pair of fasteners 90 inserted through both end sections 82 of horizontal frame members 60 and vertical frame member 62, together with the abutment of the end edges 108 of the aligned horizontal frame members 60 and the further direct abutment of a second pair of fasteners 90 against the interior faces 70a and 70b of vertical frame member 62 provide a very rigid, moment-resisting connection between the horizontal frame members 60 and the vertical frame member 62. In particular, fasteners 90 received in apertures 86a and through apertures 106 operate to rotatably fix end sections 82 to vertical frame member 62, while the abutment of fasteners 90 received through apertures 86c against faces 70a and 70b operate to prevent downward rotation of end sections 82 (i.e., under weight applied to horizontal frame members 60). The abutment of end edges 108 against one another provides further security against rotation of horizontal frame members 60, in either direction.

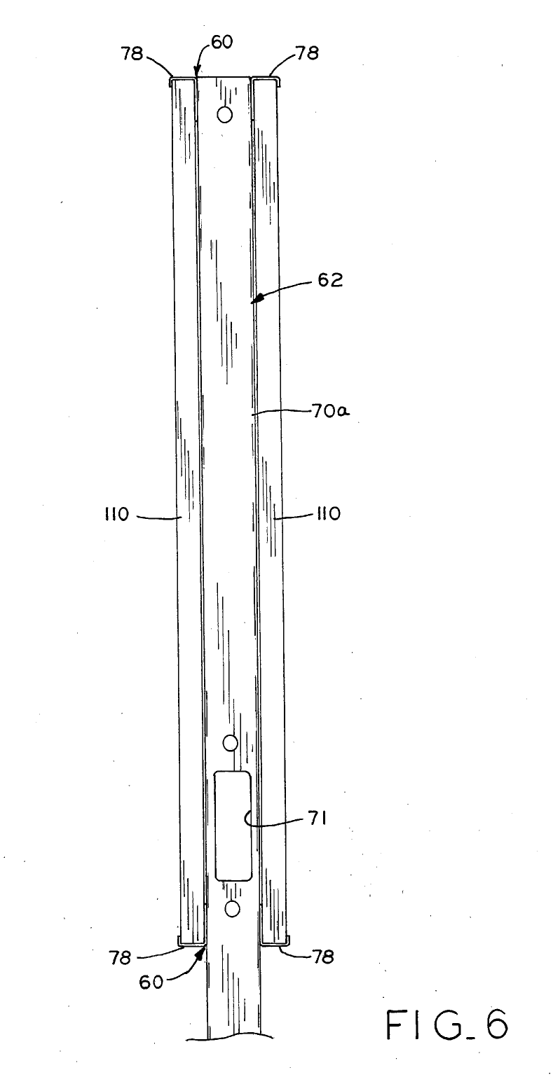

Referring to FIG. 6, tiles 110 are captured between vertically spaced pairs of tile support flanges 78 of the upper and lower horizontal frame members 60. Tiles 110 may be decorative or aesthetic tiles made of a suitable insulating or fabric-covered material or alternatively may be acoustic tiles made of an acoustic, noise-absorbing material or functional tiles including functional features such as whiteboards or slat walls. Additionally, tiles 110 may have a width which is greater than or less than the width of each framework section 64, allowing the widths of the tiles 110 to be selectively configured for functional as well as decorative purposes.

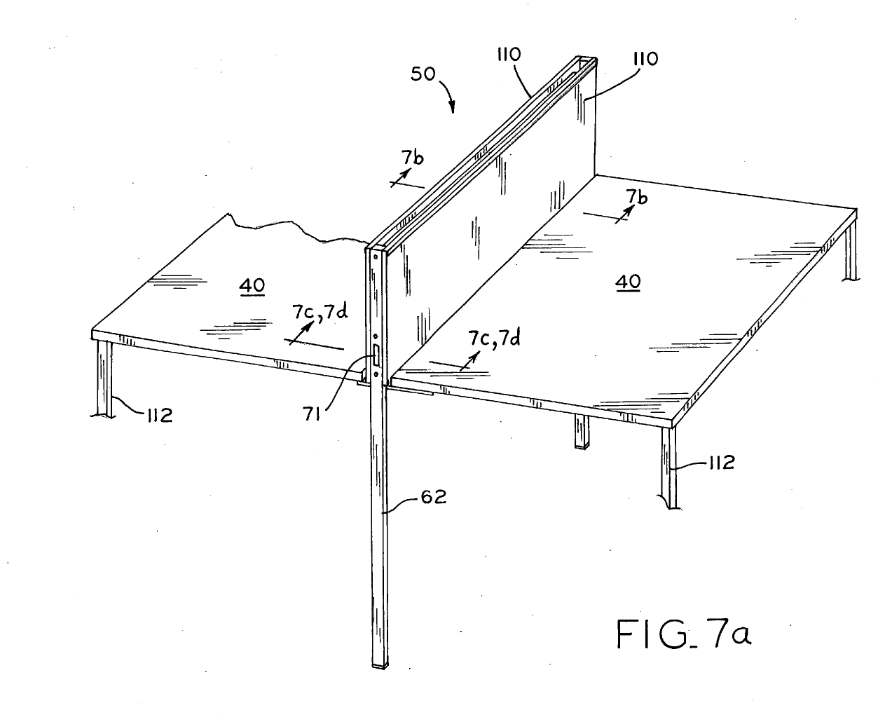

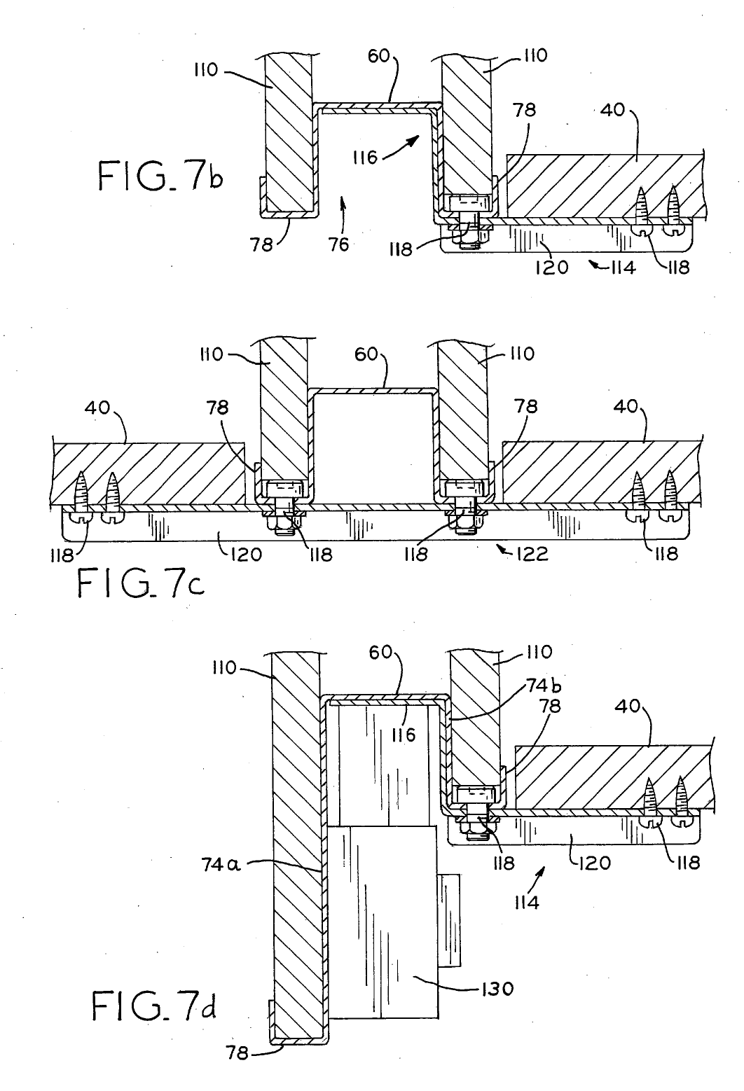

Referring to FIG. 7a, a perspective view of a section of system 30 is shown, generally including a partition and either a single work surface 40 disposed on one side of the partition as shown in FIG. 7b, or a pair of work surfaces 40 disposed in a back-to-back arrangement on opposite sides of the partition as shown in FIGS. 7c and 7d. In addition to being supported by the partition, work surfaces 40 may also be supported by one or more leg assemblies 112, as shown in FIG. 7a. As illustrated, the partition may be formed from framework 50 and a pair of tiles mounted thereto.

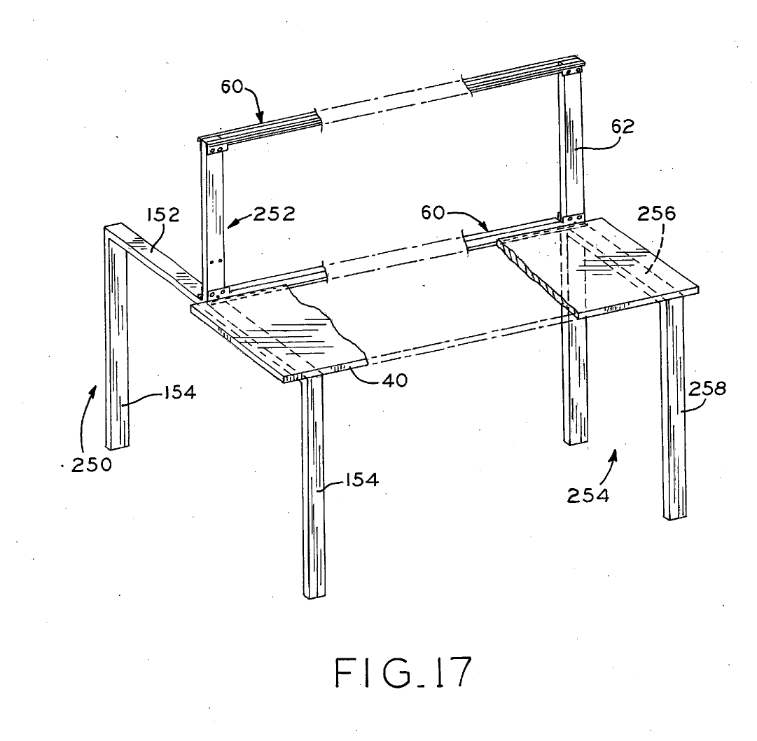

Referring to FIG. 7b, a single-sided work surface bracket 114 is shown, which generally includes an L-shaped insertion section 116 for close-fitting receipt within the lower channel 76 of horizontal frame member 60 as shown. A series of fasteners 118 are used to secure bracket 114 to the tile support flange 78 of horizontal frame member 60, and bracket 114 additionally includes a work surface mounting portion 120 extending outwardly of the side face of the partition, to which a work surface 40 may be mounted using a series of fasteners 118. The L-shaped insertion section 116 of bracket 114 aids in counteracting the tendency of bracket 114 to pivot or rotate due to the gravitational weight of work surface 40 imposed on mounting portion 120 of bracket 114. Alternatively or in addition to the L-shaped insertion bracket, a supplemental leg assembly 254 may be provided as shown in FIG. 17 and described in detail below.

Referring to FIG. 7c, a double-sided work surface bracket 122 is shown, which is formed as an elongated bent steel member which is centered with, and secured to, the pair of tile support flanges 78 of horizontal frame member 60 via fasteners 118, with a pair of work surfaces 40 respectively secured to opposite ends of bracket 122 via a plurality of fasteners 118.

Referring to FIG. 7d, an alternative arrangement includes a “high-low” horizontal frame member 60 which includes a first side wall 74a having relatively greater vertical extent and a second side wall 74b having a relatively lesser vertical extent, such that opposite tile support flanges 78 of horizontal frame member 60 are disposed at differing vertical levels. Additionally, electrical services modules 130 may be secured to the underside of horizontal frame member 60 via a suitable mounting arrangement for delivery of electrical and/or data services beneath work surface 40 and, on one side of the partition, one or more single-sided work surface brackets 114 may be used in conjunction with one or more electrical services modules 130 with the foregoing components mounted along horizontal frame member 60 in a horizontally alternating manner. Thus, in the arrangement shown in FIG. 7d, electrical and/or data services are provided on one side of the partition via electrical services modules 130 to the underside of work surface 40 while, on the opposite side of the partition, a decorative or aesthetic tile 110 is provided having no access to electrical and/or data services.

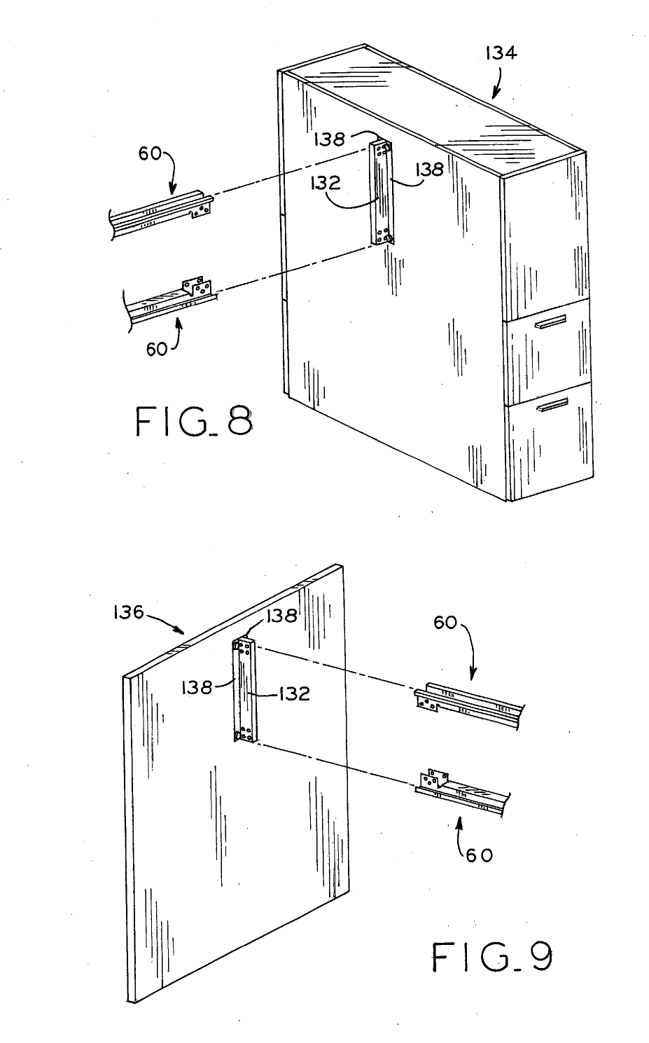

Referring to FIGS. 8 and 9, starter brackets 132 are shown, which permit a run of framework 50 to interface with a permanent wall, for example, or with a storage component 134, such as a cabinet as shown in FIG. 8, a monolithic panel 136 as shown in FIG. 9. Referring to FIG. 8, each starter bracket 132 is structurally analogous to a shortened vertical frame member 62, though further includes a pair of laterally extending, vertical flanges 138 for securing starter bracket 132 to a permanent wall or an office furniture component, such as a storage component 134 in FIG. 8, via a plurality of fasteners. Upper and lower horizontal frame members 60 may be secured to starter bracket 132 in the same manner as described above with respect to FIG. 4. Referring to FIG. 9, a starter bracket 132 is shown secured to a monolithic panel 136, and a pair of upper and lower horizontal frame members 60 may also be secured to starter bracket 132 in a like manner.

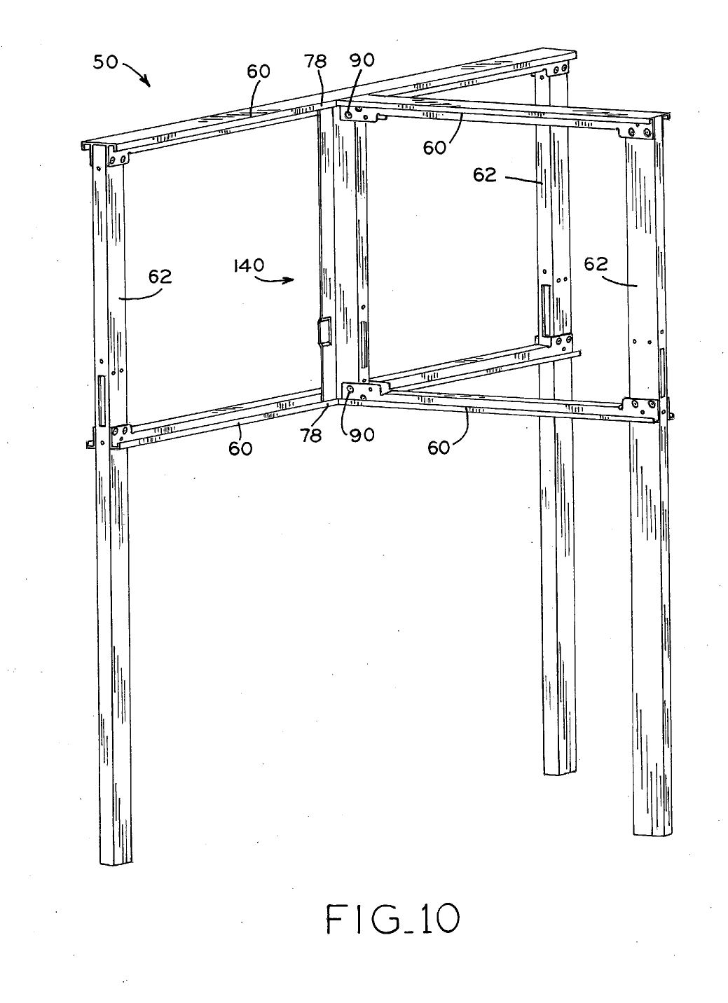

Referring to FIG. 10, an off-module bracket 140 includes upper and lower ends respectively fitted within tile support flanges 78 of upper and lower horizontal frame members 60 of an end partition framework 50, for example, in a similar fashion to the securement of tiles 110 to support flanges 78 shown in FIG. 6 and described above. The off-module bracket 140 is structurally analogous to a shortened vertical frame member 62, and the upper and lower horizontal frame members 60 of an intersecting run of framework 50 may be attached to off-module bracket 140 via fasteners 90 in the same manner as shown in FIG. 4 and described above. Advantageously, the resulting “T”-connection shown in FIG. 10 allows intersecting runs of framework 50 to be secured to one another while obviating the need for a vertical frame member 62 at the junction point to extend to the floor surface, which provides a more uniform and pleasing visual appearance. Several such “T”-connections are shown in system 30 in FIG. 1.

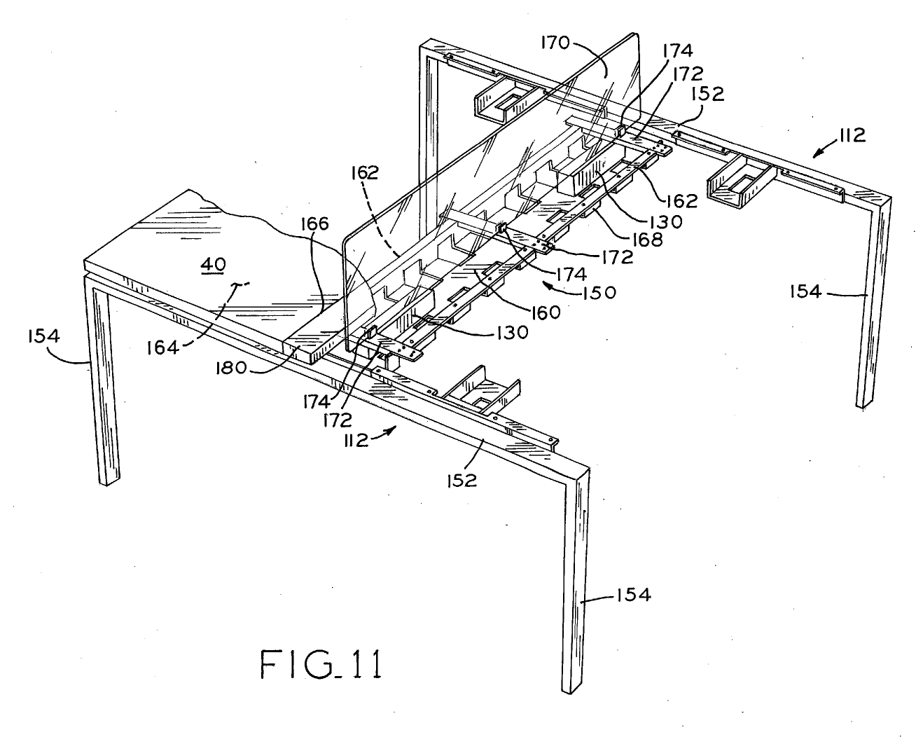

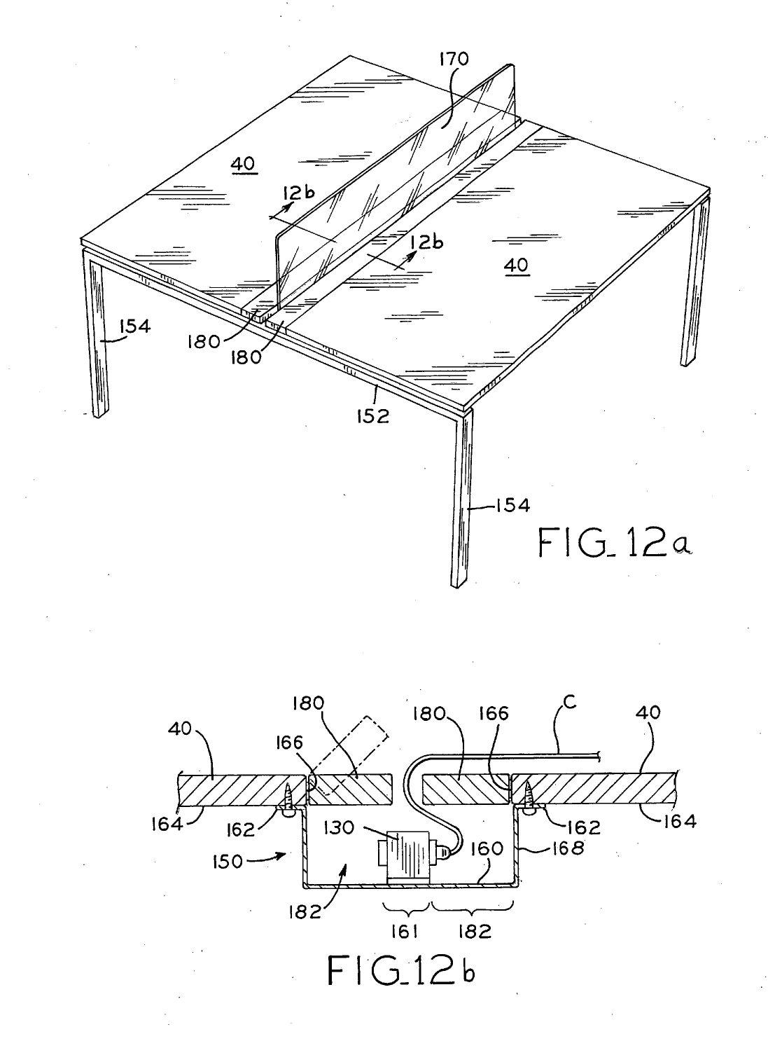

Referring to FIG. 11, a “floating” electrical services bracket 150 is illustrated in use with a desking or benching arrangement which includes a pair of leg assemblies 112 each including a horizontal beam 152 and a pair of vertical legs 154, together with a pair of work surfaces 40 mounted to leg assemblies 112 in a back-to-back arrangement (only a portion of one of which is shown for clarity). Further details of the desking system shown in FIGS. 11 and 12 may be found in U.S. patent application Ser. No. 13/484,925, entitled Office Desking System, assigned to the assignee of the present invention, the entire disclosure of which is expressly incorporated by reference herein. Referring additionally to FIG. 12b, electrical services bracket 150 may be formed of a single monolithic piece of stamped and bent steel, for example, and includes a central spine 160 disposed beneath a raceway space 161, to which one or more electrical services modules 130 may be mounted, which are disposed within the raceway space 161.

Brackets 150 also include a pair of elongate mounting flanges 162 for mounting beneath the lower faces 164 of work surfaces 40 adjacent rear edges 166 of work surfaces 40 via suitable fasteners as illustrated in FIG. 12b. Bracket 150 additionally includes a plurality of ribs 168 with openings therebetween for permitting access to electrical services modules 130 and passage of cords and cabling beneath work surfaces 40. As may be in FIG. 11, because bracket 150 is mounted to the lower faces 164 of work surfaces 40, bracket 150 need not be mounted to or directly supported by leg assemblies 112 of the desking arrangement and, in this manner, bracket 150 “floats” beneath the work surfaces 40.

A vertically-extending office furniture component may optionally be disposed above bracket 150, with the vertical office furniture component being, e.g., a partition as described further below or, as shown in FIG. 11, a screen 170. Referring to FIG. 11, a plurality of brackets 172, which may be identical to double-work surface brackets 122 shown in FIG. 7c, are mounted in transverse spanning arrangement along mounting flanges 162 of electrical services bracket 150 via suitable fasteners, and screen 170 may be captured along its lower edge by mounting clips 174 secured to brackets 172.

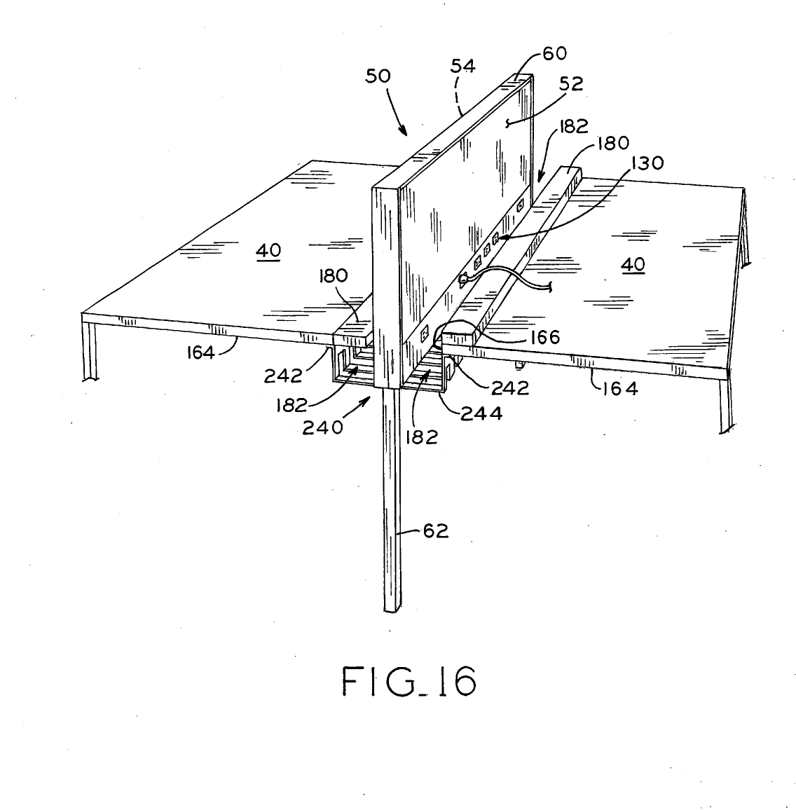

Referring to FIGS. 12a and 12b, work surfaces 40 may be provided with access covers 180 hingedly attached to the rear edges 166 of work surfaces 40 for providing selective access to access spaces 182 which are provided within electrical services bracket 150 horizontally adjacent the raceway space 161 in which electrical services modules 130 are provided. For example, as shown in FIGS. 12a and 12b, respectively, access covers 180 may be pivoted from a closed position, shown in solid lies in FIGS. 12a and 12b, in which access covers 180 substantially inhibit access to access spaces 182 and the electrical services modules 130 and an open position, shown in FIG. 16 (and in dashed lines in FIG. 12b, wherein cover 180 is partially open), in which access covers 180 are opened to allow ready access to access spaces 182 and the electrical services modules 130. Additionally, when access covers 180 are in a closed position, as shown in solid lines in FIGS. 12a and 12b, a small clearance space may be provided between access covers 180 and screen 170, for example, for routing of cords and cables C above work surface 40 in the manner shown in FIG. 12b. Access covers 180 may be made of the same substrate material as work surfaces 40 and therefore may have the same thickness as work surfaces 40. In one exemplary embodiment, access covers 180 are flush with the working surface of the adjacent work surface when in the closed position to form an extension of the effective working space.

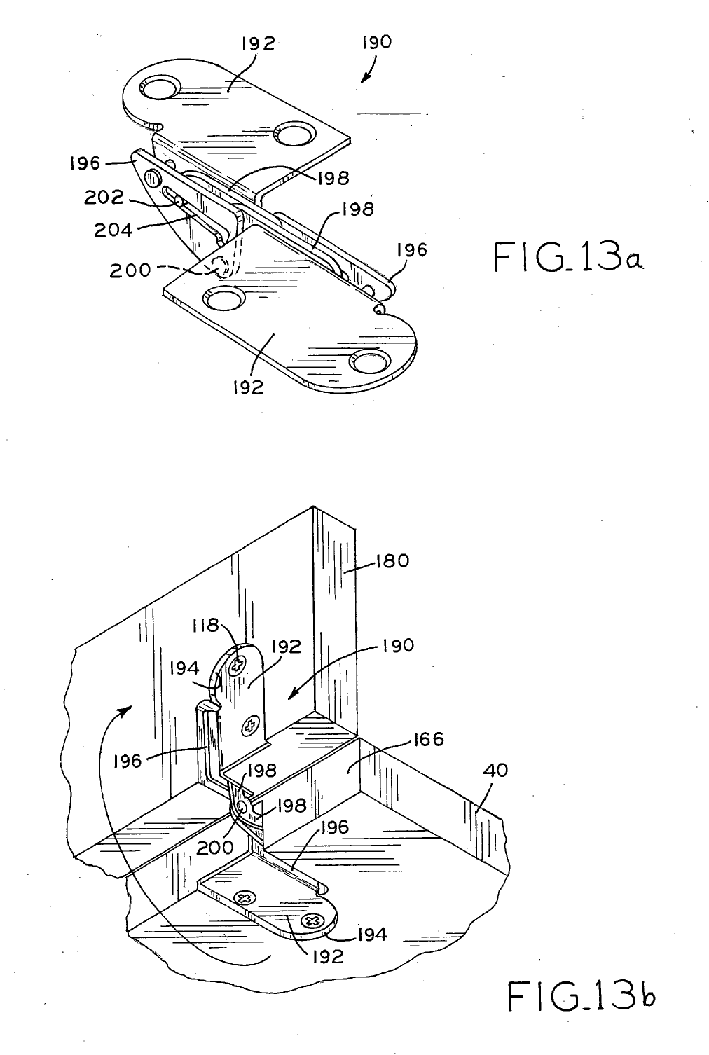

Referring to FIGS. 13a and 13b, an exemplary hinge 190 is shown for hingedly mounting access covers 180 to work surfaces 40. Hinge 190 generally includes a pair of first, horizontal plates 192 having openings for receipt of fasteners 118, which allow for securing plates 192 within recesses 194 (FIG. 13b) respectively disposed in work surfaces 40 and access covers 180. Hinges 190 also include a pair of vertical, U-shaped plates 196, and a pair of links 198 received within and connecting U-shaped plates 196. Links 198 are pivotally attached to one another at pivot point 200 and also include opposite ends having pins 202 received within slots 204 of U-shaped plates 196. In this manner, when hinge 190 is operated to move an access cover 180 with respect to the work surface 40 to which it is attached, links 198 travel with respect to plates 196 such that the pivot point 200 also travels. The components of hinge 190 are also frictionally engaged with one another such that movement of hinge 190 requires manual force and hinge 190 is normally held in a given rotational position in the absence of an applied force. Advantageously, the use of such friction hinges 190 prevents access covers 180 from falling against the upper face of work surface 40 by gravity and substantially eliminates any potential for pinching of a user's fingers, for example.

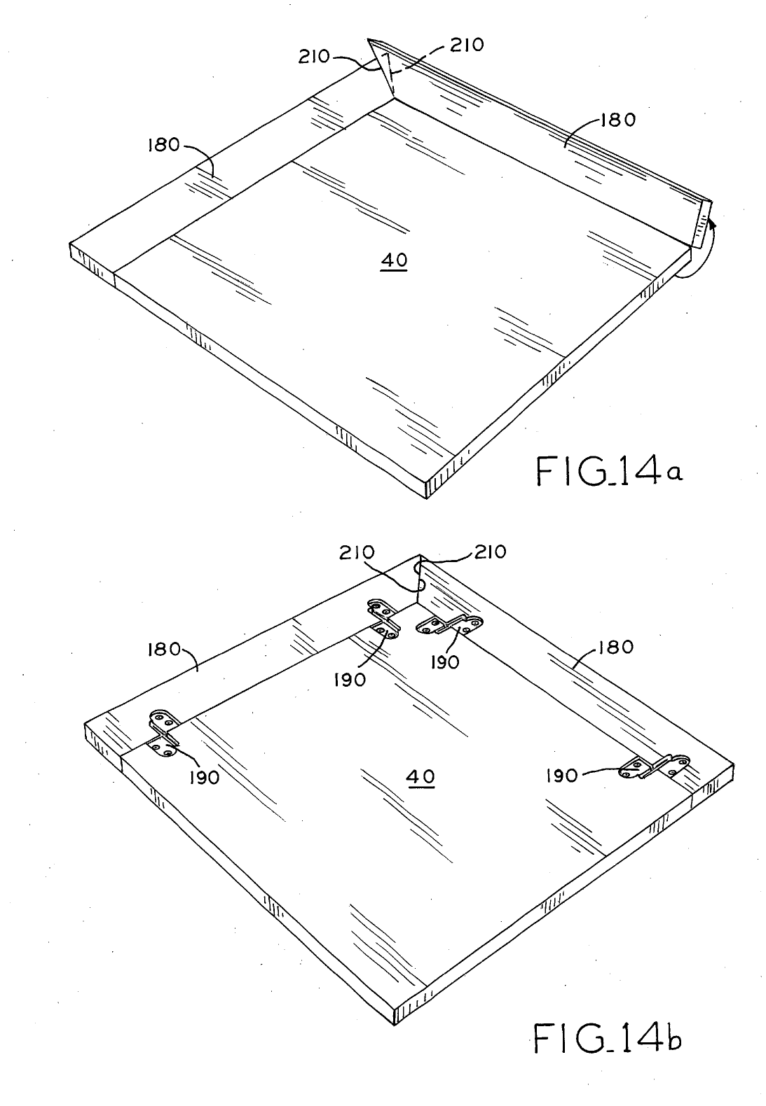

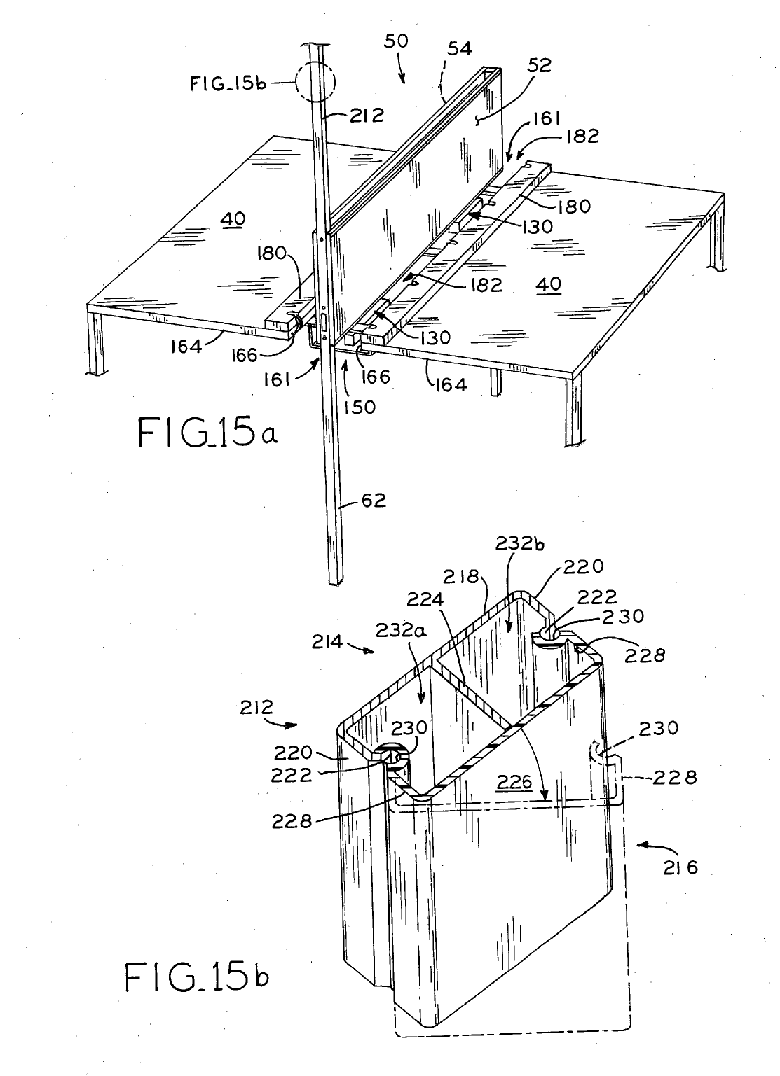

Referring to FIG. 14b, the use of discrete hinges 190 attached along the interface between a work surface 40 and its pivoting access covers 180 at spaced intervals eliminates hindrance of hinges 190 with one another at a junction between multiple access covers 180. For example, referring to FIGS. 14a and 14b, a work surface 40 adapted for use in a corner of system 30 includes a pair of access covers 180 having 45° mitered edges 210 adjacent one another, with hinges 190 adjacent the mitered edges 210 being spaced from the intersection of the mitered edges 210 with the corner of the work surface 40 as best shown in FIG. 14b. This arrangement eliminates any interference at the corner of work surface 40 which could occur with the use of piano hinges, for example. In this manner, each of the access covers 180 may be independently opened and closed relative to the other without interference between the access covers 180, yet the access covers 180 may completely cover access spaces 182 along the edges of the work surface 40 and at the corner of the work surface 40 where access covers 180 intersect one another.

Referring to FIG. 15a, a configuration including a partition together with a “floating” electronic services bracket 150 is shown. In an analogous manner to the configuration shown in FIGS. 11 and 12, the electronic services bracket 150 is attached to the lower faces 164 of a pair of back-to-back work surfaces 40, and a partition is disposed above the raceway space 161 defined by bracket 150. Work surfaces 40 may include access covers 180 for selectively providing access to access spaces 182 defined between raceway space 161 and respective front and rear side faces 52 and 54 of partition and rear edges 166 of work surfaces 40, thereby selectively providing or restricting access to electronic services modules 130 positioned within raceway space 161. Additionally, the partition may include a power pole 212 extending from a ceiling (not shown) to the upper portion of a vertical frame member 62 for routing data and/or electrical cables into the partition framework 50.

Referring to FIG. 15b, power pole 212 may include two interfitting components, namely, a relatively rigid base component 214 and a relatively resilient cover component 216. Base component 214 includes a base wall 218 and first and second side walls 220 terminating in beads 222, together with a divider wall 224 extending from base wall 218 between side walls 220. Cover component 216 includes a base wall 226 together with a pair of side walls 228 having elongated recesses 230 which are sized to fit around beads 222 of base component 214 in a snap-fit manner. In use, with cover component 216 disposed in the closed position shown in solid lines in FIG. 15b, dividing wall 224 of base component 214 divides the interior of power pole 212 into a pair of separate axially extending raceway spaces 232a and 232b for receipt of electrical and data cords or cabling, respectively, with the electrical cords/cabling and the data cords/cabling being separated from one another for ease of installation, maintenance and/or reconfiguration. Cover component 216 may be moved to an open position, shown in dashed lines in FIG. 15b, by grasping side walls 228 of cover component 216 to slightly flex same, and then selectively pivoting cover component 216 about one of the beads 222 of base component 214, with the side wall 228 of cover component 216 being released from the opposite bead 222 to thereby pivotally open cover component 216. As will be apparent from the structure described above, cover component 216 may be opened in either one of two directions based on the selection of one or the other of beads 22 of base component 214 as the hinge for opening cover components 216.

Referring to FIG. 16, a further partition configuration is shown which includes a work surface support bracket 240. The work surface support bracket 240 includes a central section mounted beneath a lower horizontal frame member 60 of the partition in the same manner as the double-sided work surface bracket 122 of FIG. 7c, together with a pair of opposite longitudinal flanges 242 secured to the lower faces 164 of at least one work surface 40 adjacent the rear edge 166 of the work surface 40. A series of ribs 244 extend between the longitudinal central section and the mounting flanges 242 of bracket 240 to allow passage of wires and cabling. The mounting flanges 242 are vertically offset from the central section of bracket 240 such that, with electrical services modules 130 mounted to the top wall 72 of the adjacent lower horizontal frame member 60 (FIG. 3) of framework 50, the work surfaces 40 are spaced slightly above the horizontal level of the electrical services modules 130. The foregoing configuration, similar to those discussed above, also provides a pair of access spaces 182 adjacent the vertical side faces 52 and 54 of the partition, which access spaces 182 may be selectively accessed and restricted via access covers 180 associated with work surfaces 40, as described above. With the access covers 180 in their closed positions (as shown for the left access cover 180 in FIG. 16), a small clearance space exists to allow passage of cords from the electrical services modules 130 above work surfaces 40.

Referring to FIG. 17, a pair of leg assemblies for a desking arrangement similar to that of FIGS. 11a and 12 are shown. A first leg assembly 250, similar to that of FIG. 12a, includes horizontal member 152 and a pair of vertical legs 154, as well as a vertical stanchion 252 having a structure analogous to that of vertical frame member 62 described above with reference to FIGS. 2, 4, and 5. A pair of horizontal frame members 60 may be secured to vertical stanchion 252 via suitable fasteners in the manner shown and described above with respect to FIG. 4. Additionally, an “h” leg assembly 254 includes a vertical frame member 62, a horizontal frame member 256 and a vertical leg 258, and a pair of horizontal frame members 60 may be secured to vertical frame member 62 of leg assembly 254 via suitable fasteners in the manner shown and described above with respect to FIG. 4. Horizontal members 152 and 256 of leg assemblies 250 and 254 may be used to support work surfaces 40 (only one of which is shown in FIG. 17 for clarity).

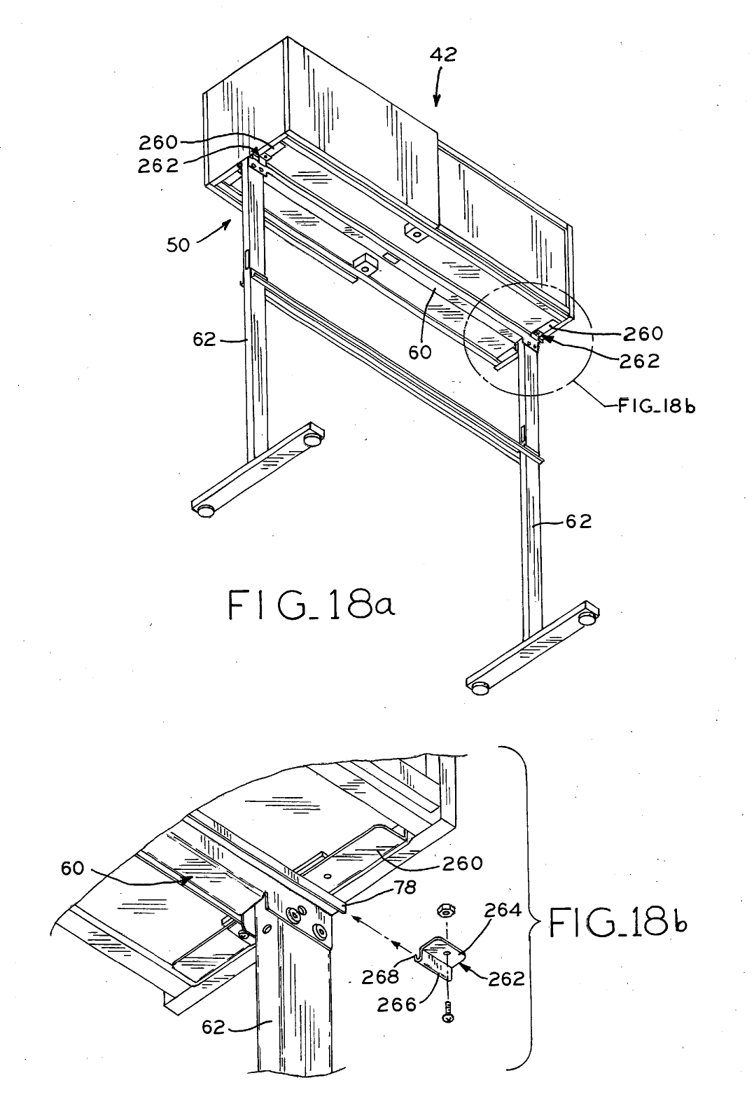

Referring to FIGS. 18a and 18b, an overhead cabinet 42 is shown which may be secured to framework 50 of a partition. Cabinet 42 includes a pair of end rails 260 which rest upon an upper horizontal frame member 60 of framework 50, and a pair of brackets 262 which include first flanges 264 (FIG. 18b) with holes for receipt of fasteners to secure same to end rails 260, as illustrated. Brackets 262 also each include second flange 266 having clip 268 which engages tile support flanges 78 of an upper horizontal frame member 60 in a clamping arrangement to secure overhead cabinet 42 to the upper horizontal frame member 60. The brackets 262 allow for longitudinal adjustment of the mounting location of cabinet 42 to the upper horizontal frame member 60 such that cabinet 42 may be located at any longitudinal position along one or more of the horizontal frame members 60 in an “off module” arrangement with respect to the framework 50 of a partition. In the illustrated embodiment, a pair of brackets 262 are attached to each of end rails 260, on either side of vertical frame member. Thus, a total of four brackets 262 may be used to attach cabinet 42 to framework 50 via frame member 60.

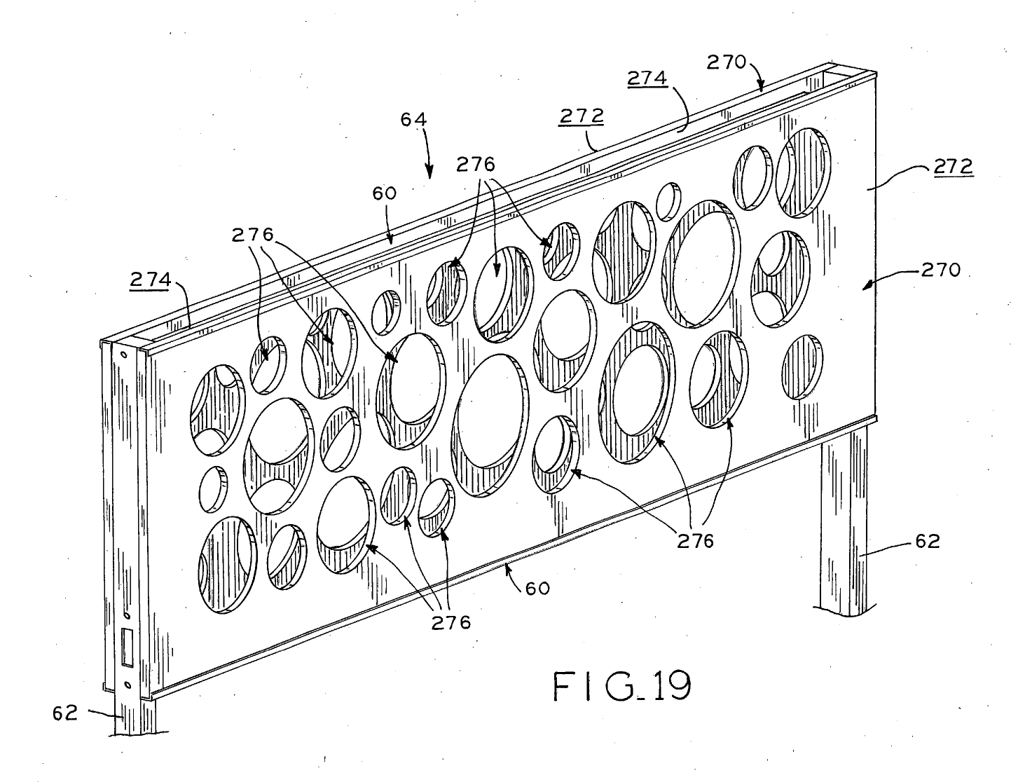

Referring to FIG. 19, a partition and tile assembly is shown, including a pair of tiles 270 that may each include a first, outer facing surface 272 and an opposite, inner facing surface 274, together with a plurality of openings 276 extending through the tile 270 between surfaces 272 and 274. One surface 272 may have a first visual element, such as a color, pattern or texture, etc., while the opposite surface 274 may have a second, different visual element, such as a color, pattern, or texture, etc. When a pair of such tiles 270 are mounted to opposite sides of a framework section 64 of a partition, the inner facing surface 274 of one tile 270 will be visible through openings 276 from the outer facing surface 272 of the opposite tile 270, which provides a visually pleasing “three-dimensional” effect due to the contrast in the color(s), pattern(s), or texture(s) of the surfaces.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1-12. (canceled)

13. An office furniture system, comprising:
a framework including a plurality of vertical frame members and a plurality of horizontal frame members, said framework defining opposite vertical side faces and said vertical and horizontal frame members further defining a framework interior;
at least one of said vertical frame members comprising:
opposite front and rear faces respectively facing said vertical side faces of said framework; and
a pair of opposite interior faces respectively extending between said front and rear faces, said interior faces each facing toward said framework interior;
a first one of said horizontal frame members comprising a pair of end sections disposed in respective overlapping relationship with said front and rear faces of said vertical frame member;
a first fastener extending through said end sections of said first horizontal frame member and said front and rear faces of said vertical frame member to rigidly connect said first horizontal frame member and said vertical frame member; and
a second fastener spaced from said first fastener and extending through said first horizontal frame member, said second fastener abutting one of said interior faces of said vertical frame member.

14. The system of claim 13, further comprising a second horizontal frame member comprising a pair of end sections, said first and second horizontal frame members connected to opposite sides of said vertical frame member in a joint arrangement, comprising:
said pair of end sections of said first horizontal frame member disposed in respective overlapping relationship with first portions of said front and rear faces of said vertical frame member;
said pair of end sections of said second horizontal frame member disposed in respective overlapping relationship with second portions of said front and rear faces of said vertical frame member, said first and second horizontal frame members horizontally aligned with one another;
said first fastener extending through said end sections of said first horizontal frame member and said first portion of said front and rear faces of said vertical frame member;
said second fastener spaced from said first fastener and extending through said first horizontal frame member, said second fastener abutting one of said interior faces of said vertical frame member;
a third fastener extending through said end sections of said second horizontal frame member and said second portion of said front and rear faces of said vertical frame member; and
a fourth fastener spaced from said third fastener and extending through said second horizontal frame member, said fourth fastener abutting the other of said interior faces of said vertical frame member.

15. The system of claim 14, wherein said end sections of said first and second horizontal frame members include respective end faces edges, said respective end edges of said end sections of said first and second horizontal frame members disposed in abutment with one another on adjacent each of said front and rear faces of said vertical frame member.

16. The system of claim 13, wherein said first and second fasteners each include:
a first component including a first head and an internally threaded shaft; and
a second component including a second head and an externally threaded shaft.

17. The system of claim 14, wherein said first and second horizontal frame members are identical to one another and are disposed in 180° rotationally opposite positions.

18. The system of claim 14, wherein said first and second horizontal frame members each include a side flange defining a channel, further comprising at least one tile captured within said channels and at least partially covering said framework.

19. The system of claim 14, wherein at least one of said first and second horizontal frame members further comprises:
a horizontal top flange; and
a pair of side flanges defining channels on respective opposite sides of said top flange.

20. The system of claim 13, wherein said first fastener is closely received within respective apertures in said end sections of said first horizontal frame member and said front and rear faces of said vertical frame member wherein said first horizontal frame member and said vertical frame member are positively located with respect to one another.

21. An office furniture system, comprising:
a framework including a pair of vertical frame members and a pair of upper and lower horizontal frame members extending between and connecting said vertical frame members, said framework defining opposite vertical side faces and said vertical and horizontal frame members further defining a framework interior;
each of said vertical frame members comprising:
opposite front and rear faces respectively facing said vertical side faces of said framework; and
a pair of opposite interior faces respectively extending between said front and rear faces, said interior faces each facing toward said framework interior;
each of said upper and lower horizontal frame members comprising opposite ends, each end having a pair of end sections disposed in respective overlapping relationship with said front and rear faces of a respective said vertical frame member;
first fasteners extending through each said end section of said upper and lower horizontal frame members and respective said front and rear faces of a said vertical frame member to rigidly connect said upper and lower horizontal frame members and said vertical frame members; and
second fasteners spaced from said first fasteners and extending through respective said upper and lower horizontal frame members, said second fasteners abutting said interior faces of said vertical frame members.

22. The system of claim 21, wherein said first and second fasteners each include:
a first component including a first head and an internally threaded shaft; and
a second component including a second head and an externally threaded shaft.

23. The system of claim 21, wherein said upper and lower horizontal frame members are identical to one another and are disposed in 180° rotationally opposite positions.

24. The system of claim 21, wherein said upper and lower horizontal frame members each include a side flange defining a channel, further comprising at least one tile captured within said channels and at least partially covering said framework.

25. The system of claim 21, wherein at least one of said upper and lower horizontal frame members further comprises:
a horizontal top flange; and
a pair of side flanges defining channels on respective opposite sides of said top flange.

26. The system of claim 21, wherein said first fastener is closely received within respective apertures in said end sections of said first horizontal frame member and said front and rear faces of said vertical frame member wherein said first horizontal frame member and said vertical frame member are positively located with respect to one another.
